(19) United States
(12) Patent Application Publication
(10) Pub. No.: US 2008/0151879 A1
(43) Pub. Date: Jun. 26, 2008

(54) Method and Apparatus to Facilitate Substituting a Standard Telephone for an Internet Protocol-Compatible Telephone Using a Same Telephone Number

(75) Inventors: Francis Waldman, Fair Haven, NJ (US); Manish Gupta, Old Bridge, NJ (US)

Correspondence Address: UTSTARCOM, INC. / FETF, 120 S. LASALLE STREET, SUITE 1600, CHICAGO, IL, 60603-3406, US

(73) Assignee: UTSTARCOM, INC., Alameda, CA (US)

(21) Appl. No.: 11/616,053

(22) Filed: Dec. 26, 2006

(51) Int. Cl. H04L 7/00

(52) U.S. Cl. 370/356

(57) ABSTRACT

A platform (300) that supports (101) voice over Internet Protocol services for an Internet Protocol-compatible telephone (401), in response to detecting (102) that a given telephone-side capability of supporting the voice over Internet Protocol services for the Internet Protocol-compatible telephone is impaired, can automatically substitute (103) a standard telephone (402) for the Internet Protocol-compatible telephone such that a same telephone number as is used for the Internet Protocol-compatible telephone is also used for the standard telephone. This can comprise, at least in part, automatically interacting with a Session Initiation Protocol proxy server to facilitate the redirection of calls for the Internet Protocol-compatible telephone.

### TECHNICAL FIELD

This invention relates generally to Internet Protocol-compatible telephones.

### BACKGROUND

Use of voice over Internet Protocol (VoIP) to effect real-time voice communications, including telephone calls, is a known and growing area of interest and endeavor. This approach can serve in many instances to provide less expensive telephonic services and can also be used in conjunction with corresponding data-based services such as video and the like. In some cases, Internet Protocol-compatible telephones are now being used to provide the user with a telephone form factor and user interface while permitting the use of voice over Internet Protocol to facilitate desired voice communications.

There are times when this approach, however, leads to user dissatisfaction. In many cases, for example, the Internet Protocol-compatible telephone couples to the Internet via a corresponding Digital Subscriber Line (DSL). Unfortunately, there are various reasons (such as loss of power, a noisy DSL line, failure of Point-to-Point Protocol over Ethernet (PPPOE) connectivity, and so forth) why such Digital Subscriber Line services can become temporarily (and usually without advance notice) unavailable. When such services become unavailable, the ability to make and/or sustain a voice over Internet Protocol session fails as well. This can lead to dropped calls and to an inability to make or receive a call during the service interruption.

To meet this problem, some prior art teachings suggest providing a standard telephone as a backup platform. Unfortunately, such a telephone has a different telephone number than the Internet Protocol-compatible telephone and this can lead to considerable confusion and difficulties in practice. As but one example in this regard, a calling party will not likely know which telephone number to use when calling a party having two such telephones.

### BRIEF DESCRIPTION OF THE DRAWINGS

The above needs are at least partially met through provision of the method and apparatus to facilitate substituting a standard telephone for an Internet Protocol-compatible telephone using a same telephone number described in the following detailed description, particularly when studied in conjunction with the drawings, wherein:

FIG. 1 comprises a flow diagram as configured in accordance with various embodiments of the invention;

FIG. 2 comprises a call flow diagram as configured in accordance with various embodiments of the invention;

FIG. 3 comprises a block diagram as configured in accordance with various embodiments of the invention; and

FIG. 4 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a platform that supports voice over Internet Protocol services for an Internet Protocol-compatible telephone, in response to detecting that a given telephone-side capability for supporting the voice over Internet Protocol services for the Internet Protocol-compatible telephone is impaired, can automatically substitute a standard telephone for the Internet Protocol-compatible telephone such that a same telephone number as is used for the Internet Protocol-compatible telephone is also used for the standard telephone. This can comprise, at least in part, automatically interacting with a Session Initiation Protocol proxy server to facilitate the redirection of calls for the Internet Protocol-compatible telephone.

By one approach, this can comprise using information that pertains to an earlier interaction between the Session Initiation Protocol proxy server and the Internet Protocol-compatible telephone. This can also comprise, if desired, converting analog audio content sourced by the standard telephone into Internet Protocol-compatible content and, conversely, converting Internet Protocol-compatible content to be delivered to the standard telephone into analog audio content that can be compatibly received by the standard telephone.

So configured, appropriate actions can be taken when a disruption occurs during the course of an on-going voice over Internet Protocol session to direct the call session to the standard telephone before system time-outs drop the call. This, in turn, permits the user to shift to the standard telephone and to continue with their call-in-progress notwithstanding the Digital Subscriber Line service having failed. By providing for both telephones to make appropriate use of a same telephone number, of course, the prior art issues in this regard are also largely avoided.

Those skilled in the art will appreciate that these teachings are readily realized in economically feasible ways that avoid the need to alter in any way the telephone platforms of the user or that require the instantiation of any new Internet Protocol messages or the like. These teachings are also readily scaled to suit the needs and/or opportunities of a given application setting.

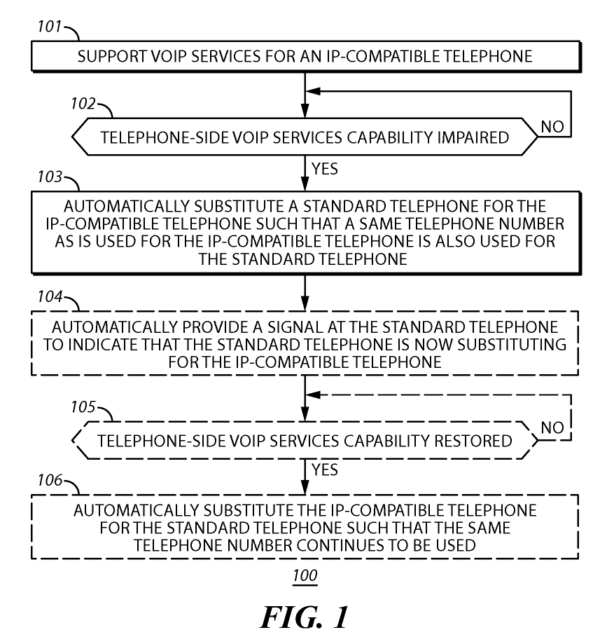

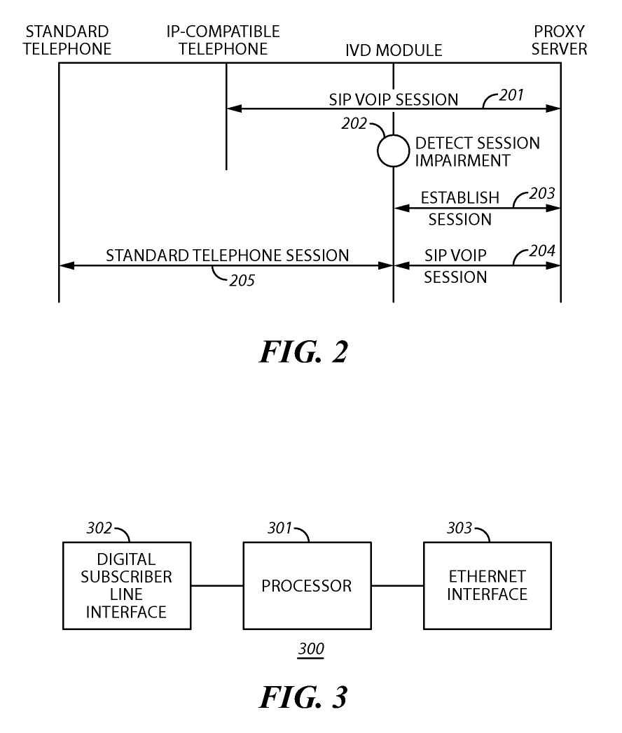

These and other benefits may become clearer upon making a thorough review and study of the following detailed description. Referring now to the drawings, and in particular to FIGS. 1 and 2, an illustrative example of a process 100 that can be carried out by a suitable platform such as, but not limited to, an integrated voice data module (IVD) as may comprise a part of an Internet Protocol Digital Subscriber Line Access Multiplexer (IP DSLAM) as may comprise a part of a so-called telco central office and as is otherwise known in the art. These teachings are applied in conjunction with supporting 101 voice over Internet Protocol (VoIP) services for a given Internet Protocol-compatible telephone (by, for example, supporting a Session Initiation Protocol (SIP) voice over Internet Protocol session 201 between the Internet Protocol-compatible telephone and a corresponding proxy server). The latter comprises a well-understood area of endeavor and requires no further description here.

This process 100 then provides for detecting 102 when one or more given telephone-side capabilities for supporting the voice over Internet Protocol services for the Internet Protocol-compatible telephone becomes impaired. This can be accomplished in any of a variety of ways. For example, this can comprise detecting a failure with respect to a Digital Subscriber Line capability. As another example, this can comprise detecting a failure with respect to a Point-to-Point over Ethernet capability. As yet another example, this can comprise detecting a failure with respect to a Session Initiation Protocol domain requirement. Other examples are no doubt available and other relevant detection criteria may be developed in the future that are suitable for use in this application setting.

By one approach, this step of detecting session impairment can be further conditioned upon one or more other criteria of concern. As but one example in this regard, this process 100 can be configured and arranged to require that such impairment continuously persist for some minimal amount of time (such as one second, five seconds, or some other duration of choice) before such impairment is “detected” as described.

Upon detecting a session impairment 202, this process 100 then provides for automatically substituting 103 a standard telephone for the Internet Protocol-compatible telephone. This can comprise, if desired, automatically interacting with the above-mentioned Session Initiation Protocol proxy server to arrange for redirecting calls for the Internet Protocol-compatible telephone (both incoming and outgoing). By one approach, this can comprise establishing an appropriate session 203, such as a Session Initiation Protocol session, between the implementing platform (such as the aforementioned IVD module) and the aforementioned proxy server. This, in turn, can be based, at least in part, upon use of information (such as information regarding the telephone number that is used by the Internet Protocol-compatible telephone) that pertains to an earlier interaction between the Session Initiation Protocol proxy server and the Internet Protocol-compatible telephone.

By one approach, this step can comprise arranging, as between the Session Initiation Protocol proxy server and the implementing platform, a continued use of the same telephone number for the standard telephone as was being employed for the Internet Protocol-compatible telephone. This can comprise, for example, using Session Initiation Protocol to re-register the phone number (using a process in 301 as a proxy) with the Session Initiation Protocol proxy server using the same telephone number as was previously (and currently) being used for the Internet Protocol-compatible telephone and the Internet address of the proxy process in 301. This re-registration can also, if desired, convey information regarding the capabilities of the standard telephone as opposed to the capabilities of the Internet Protocol-compatible telephone.

In most cases, of course, this newly established session 203 will comprise a voice over Internet Protocol session. The standard telephone, however, will typically be unable to make direct use of such information. The above-described step of automatically substituting 103 the standard telephone for the Internet Protocol-compatible telephone can also comprise, therefore and as desired, supporting both the voice over Internet Protocol session 204 and an analog standard telephone session 205. This can also comprise, as appropriate, converting analog audio content as is sourced by the standard telephone into Internet Protocol-compatible content and converting Internet Protocol-compatible content to be delivered to the standard telephone into analog audio content that can be compatibly received by the standard telephone.

So configured, the enabling platform can respond to a loss of VoIP session integrity by automatically interacting with the appropriate proxy server to register the standard telephone as the new entity to associate with the same telephone number as had previously been associated with the Internet Protocol-compatible telephone and to arrange for both future and a present communication session to now be routed via the enabling platform to the standard telephone. The voice content, in turn, is appropriately translated in form to ensure compatible use by all session participants.

Other corresponding actions are also possible, if desired. As one example in this regard, this process 100 can optionally provide for automatically providing 104 a signal, such as an audio signal and/or a flashing light or other display, at the standard telephone to indicate that the standard telephone is now substituting for the Internet Protocol-compatible telephone. Such a signal can then be used and relied upon by a telephone user to alert them of such a status. When such substitution occurs during the course of a present telephone call, for example, such a signal emanating from the standard telephone can serve to alert the user that their attention should be shift from use of the Internet Protocol-compatible telephone to the standard telephone as loss of the present session on the Internet Protocol-compatible telephone may not always be otherwise immediately obvious to the user.

The described steps, of course, are generally intended as a backup capability; eventually, one expects the Internet Protocol-compatible telephone to again become usable for its intended purpose. Therefore, and again if desired, this process 100 will also optionally accommodate detecting 105 when the telephone-side voice over Internet Protocol capability is restored. When this occurs, this process 100 can then optionally accommodate automatically substituting 106 the Internet Protocol-compatible telephone for the standard telephone such that, again, the same telephone number continues to be used for the Internet Protocol-compatible telephone as was also used for the standard telephone.

Such a switch can again be rendered through appropriate registration (and/or re-registration) of the same phone number with the Internet address of the Internet Protocol-compatible telephone with the Session Initiation Protocol proxy server. For example, by one approach, the Internet Protocol-compatible phone when powered can continuously attempt to reestablish the connection to the Proxy Server. Process 301 can monitor the phone's communications with the Session Initiation Protocol server and when the registration succeeds the process will not persist with using itself as the proxy for the standard phone (unless and until, of course, the described process 100 detects a new failure). In many cases it may be useful to further condition this automatic substitution capability by requiring that the standard telephone call have concluded before permitting such a substitution.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 3, an illustrative approach to such a platform will now be provided.

In this general depiction the enabling platform 300 is comprised of a processor 301 that operably couples to a Digital Subscriber Line interface 302 and an Ethernet interface 303. The former can serve to provide a link to both the aforementioned Internet Protocol-compatible telephone and the standard telephone (with a more specific example being provided further below). The Ethernet interface 303, in turn, provides a link to the aforementioned Session Initiation Protocol proxy server and to the Internet or other network of choice as appropriate.

The processor 301 can comprise a partially or wholly programmable platform as are known in the art. This processor 301 can be configured and arranged (via, for example, corresponding programming) to carry out any or all of the teachings as are set forth herein. This can comprise, or example, supporting voice over Internet Protocol services for the Internet Protocol-compatible telephone that is coupled to the Digital Subscriber Line interface 302, detecting impairment of such services, and automatically substituting the standard telephone that is also coupled to the Digital Subscriber Line interface 302 for the Internet Protocol-compatible telephone in a manner that preserves continued use of the same telephone number for both telephones. This can also comprise converting audio content as described above, facilitating provision of the aforementioned signal at the standard telephone, and automatic substitution of the Internet Protocol-compatible telephone for the standard telephone when the former can again be satisfactorily supported.

Those skilled in the art will recognize and understand that such an apparatus 300 may be comprised of a plurality of physically distinct elements as is suggested by the illustration shown in FIG. 3. It is also possible, however, to view this illustration as comprising a logical view, in which case one or more of these elements can be enabled and realized via a shared platform. It will also be understood that such a shared platform may comprise a wholly or at least partially programmable platform as are known in the art.

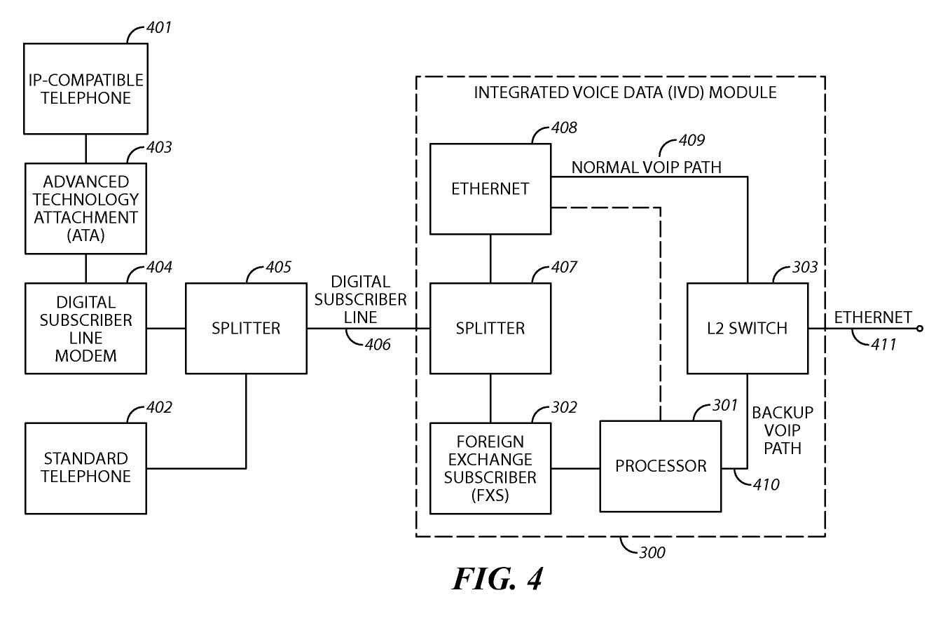

Referring now to FIG. 4, a more specific illustrative example will be provided. Those skilled in the art will recognize and understand that this example is offered for the purposes of illustration only and does not serve, nor is it intended to serve, as an exhaustive offering in this regard.

As illustrated, an Internet Protocol-compatible telephone 401 of choice can couple to a Digital Subscriber Line modem 404 via, for example, an Advanced Technology Attachment 403 (ATA; also often known in the art as Integrated (or Intelligent) Drive Electronics (IDE)) of choice. In addition, this illustrative example provides for a standard telephone 402 of choice. Both the standard telephone 402 and the Internet Protocol-compatible telephone 401 (via the previously mentioned components) couple to a splitter 405 which in turn couples to a Digital Subscriber Line 406. All of these components are well known in the art. As these teachings are not particularly sensitive to the selection of any particular choices in this regard, for the sake of brevity and the preservation of narrative focus further elaboration regarding such components is not provided here.

The aforementioned Digital Subscriber Line 406 couples, in turn, to an enabling platform 300 that comprises, in this illustrative example, an integrated voice data module as may comprise a part of an IP DSLAM. In particular, the Digital Subscriber Line 406 can couple to another splitter 407 that couples, in turn, to Ethernet elements 408 that serve to comprise and support a normal voice over Internet Protocol path 409 and to a foreign exchange subscriber (FXS) that serves, at least in part, as the above-mentioned Digital Subscriber Line interface 302. The latter, in turn, couples to the above-mentioned processor 301 to thereby effectively comprise a backup voice over Internet Protocol path 410. If desired, the processor 301 can also operably couple to the aforementioned Ethernet elements 408 in order to facilitate appropriate monitoring and/or control in accordance with the present teachings.

Both the normal voice over Internet Protocol path 409 and the backup voice over Internet Protocol path 410 couple in this example to an L2 switch that serves, in turn, as the aforementioned Ethernet interface 303 and that couples via Ethernet 411 to, for example, the Internet or other network of choice.

So configured, the processor 301 can remain apprised of the functionality of the telephone-side capability of the Digital Subscriber Line 406. (As used herein, those skilled in the art will understand that the expression “telephone-side” refers to those components and paths that are downstream of the enabling platform and towards (or including) the Internet Protocol-compatible telephone 401.) This information, in turn, can be used to facilitate the above-described automated interaction with a corresponding proxy server via the Ethernet link 411. The processor 301 is also well positioned to then facilitate the substitution of the standard telephone 402 for the Internet Protocol-compatible telephone 401 by appropriately processing and translating analog voice content into Internet Protocol-compatible content and vice versa.

Those skilled in the art will recognize and appreciate that these teachings are readily implemented with little in the way of retrofitting being required for virtually all of the illustrated components. In particular, neither the telephones nor the proxy server need special programming or alteration in order to benefit from these teachings. Those skilled in the art will also understand and appreciate the benefit of providing for substitution of a standard telephone for an Internet Protocol-compatible telephone during a time of need while preserving the use of only a single common telephone number.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
supporting voice over Internet Protocol services for an Internet Protocol-compatible telephone;
in response to detecting that a given telephone-side capability of supporting the voice over Internet Protocol services for the Internet Protocol-compatible telephone is impaired, automatically substituting a standard telephone for the Internet Protocol-compatible telephone such that a same telephone number as is used for the Internet Protocol-compatible telephone is also used for the standard telephone.

2. The method of claim 1 wherein automatically substituting a standard telephone for the Internet Protocol-compatible telephone comprises, at least in part, automatically interacting with a Session Initiation Protocol proxy server to redirect calls for the Internet Protocol-compatible telephone.

3. The method of claim 2 wherein automatically interacting with a Session Initiation Protocol proxy server to redirect calls for the Internet Protocol-compatible telephone comprises, at least in part, using information that pertains to an earlier interaction between the Session Initiation Protocol proxy server and the Internet Protocol-compatible telephone.

4. The method of claim 1 wherein automatically substituting a standard telephone for the Internet Protocol-compatible telephone comprises, at least in part, at least one of:
converting analog audio content sourced by the standard telephone into Internet Protocol-compatible content;
converting Internet Protocol-compatible content to be delivered to the standard telephone into analog audio content that can be compatibly received by the standard telephone.

5. The method of claim 4 wherein automatically substituting a standard telephone for the Internet Protocol-compatible telephone comprises, at least in part, both of:
converting analog audio content sourced by the standard telephone into Internet Protocol-compatible content;
converting Internet Protocol-compatible content to be delivered to the standard telephone into analog audio content that can be compatibly received by the standard telephone.

6. The method of claim 1 further comprising:
detecting that the given telephone-side capability of supporting the voice over Internet Protocol services for the Internet Protocol-compatible telephone is impaired.

7. The method of claim 6 wherein detecting comprises at least one of:
detecting a failure with respect to a Digital Subscriber Line capability;
detecting a failure with respect to a Point-to-Point over Ethernet capability;
detecting a failure with respect to a Session Initiation Protocol domain requirement.

8. The method of claim 1 further comprising:
automatically providing a signal at the standard telephone to indicate that the standard telephone is now substituting for the Internet Protocol-compatible telephone.

9. The method of claim 8 wherein the signal comprises an audio signal.

10. The method of claim 1 further comprising:
in response to detecting that the given telephone-side capability is again capable of supporting the voice over Internet Protocol services for the Internet Protocol-compatible telephone, automatically substituting the Internet Protocol-compatible telephone for the standard telephone such that the same telephone number continues to be used for the Internet Protocol-compatible telephone as was also used for the standard telephone.

11. The method of claim 10 wherein automatically substituting the Internet Protocol-compatible telephone for the standard telephone comprises only automatically substituting the Internet Protocol-compatible telephone for the standard telephone upon a conclusion of a call as is presently ongoing when detecting that the given telephone-side capability is again capable of supporting the voice over Internet Protocol services for the Internet Protocol-compatible telephone

12. An apparatus comprising:
a Digital Subscriber Line interface;
an Ethernet interface;
a processor operably coupled to the Digital Subscriber Line interface and the Ethernet interface that is configured and arranged to:
support voice over Internet Protocol services for an Internet Protocol-compatible telephone that is coupled to the Digital Subscriber Line interface;
in response to detecting that a given Digital Subscriber Line-side capability of supporting the voice over Internet Protocol services for the Internet Protocol-compatible telephone is impaired, automatically substituting a standard telephone that is also coupled to the Digital Subscriber Line interface for the Internet Protocol-compatible telephone such that a same telephone number as is used for the Internet Protocol-compatible telephone is also used for the standard telephone.

13. The apparatus of claim 12 wherein the processor is further configured and arranged to automatically substitute the standard telephone for the Internet Protocol-compatible telephone comprises, at least in part, by automatically interacting with a Session Initiation Protocol proxy server to redirect calls for the Internet Protocol-compatible telephone.

14. The apparatus of claim 13 wherein the processor is further configured and arranged to automatically interact with a Session Initiation Protocol proxy server to redirect calls for the Internet Protocol-compatible telephone by, at least in part, using information that pertains to an earlier interaction between the Session Initiation Protocol proxy server and the Internet Protocol-compatible telephone.

15. The apparatus of claim 12 wherein the processor is further configured and arranged to automatically substitute a standard telephone for the Internet Protocol-compatible telephone by, at least in part, facilitating at least one of:
converting analog audio content sourced by the standard telephone into Internet Protocol-compatible content;
converting Internet Protocol-compatible content to be delivered to the standard telephone into analog audio content that can be compatibly received by the standard telephone.

16. The apparatus of claim 15 wherein the processor further configured and arranged to automatically substituting the standard telephone for the Internet Protocol-compatible telephone by, at least in part, both of:
converting analog audio content sourced by the standard telephone into Internet Protocol-compatible content;
converting Internet Protocol-compatible content to be delivered to the standard telephone into analog audio content that can be compatibly received by the standard telephone.

17. The apparatus of claim 12 wherein the processor is further configured and arranged to automatically facilitate provision of a signal at the standard telephone to indicate that the standard telephone is now substituting for the Internet Protocol-compatible telephone.

18. The apparatus of claim 17 wherein the signal comprises an audio signal.

19. The apparatus of claim 12 wherein the processor is further configured and arranged to, in response to detecting that the given Digital Subscriber Line-side capability is again capable of supporting the voice over Internet Protocol services for the Internet Protocol-compatible telephone, automatically substitute the Internet Protocol-compatible telephone for the standard telephone such that the same telephone number continues to be used for the Internet Protocol-compatible telephone as was also used for the standard telephone.

20. The apparatus of claim 19 wherein the processor is further configured and arranged to automatically substitute the Internet Protocol-compatible telephone for the standard telephone comprises only upon a conclusion of a call as is presently ongoing when detecting that the given telephone-side capability is again capable of supporting the voice over Internet Protocol services for the Internet Protocol-compatible telephone.

21. The apparatus of claim 12 wherein the apparatus comprises an integrated voice data module.
